(19) United States
(12) Patent Application Publication
(10) Pub. No.: US 2008/0208607 A1
(43) Pub. Date: Aug. 28, 2008

(54) Method and Apparatus For Providing Customized Contents Based on Terminal Information

(75) Inventors: Jin Suk Ma, Daejeon-city (KR); Min Hong Yun, Daejeon-city (KR); Sun Ja Kim, Daejeon-city (KR)

Correspondence Address: LOWE HAUPTMAN HAM & BERNER, LLP, 1700 DIAGONAL ROAD, SUITE 300, ALEXANDRIA, VA, 22314, US

(73) Assignee: ELECTRONICS AND TELECOMMUNICATIONS RESEARCH INSTITUTE, Daejeon-City (KR)

(21) Appl. No.: 11/993,988

(22) PCT Filed: Dec. 6, 2006
(86) PCT No.: PCT/KR2006/005248

§ 371 Date: Dec. 27, 2007

(30) Foreign Application Priority Data
Dec. 7, 2005 (KR) 10-2005-0119075
Jul. 6, 2006 (KR) 10-2006-0063471

(51) Int. Cl. G06Q 30/00; G06F 15/16

(52) U.S. Cl. 705/1; 709/203

(57) ABSTRACT

Provided is a method and apparatus for providing customized contents based on terminal information. The method includes obtaining information on a terminal that operates contents; if a user selects contents, determining whether the selected contents are available or if it is necessary to request a contents provider to provide the contents, if necessary, requesting the contents provider to provide the contents via a predetermined communication network and receiving the contents from the contents provider; determining whether a file format of the available contents or the received contents is converted in order to perform the contents in the terminal, and if necessary, converting the file format of the contents, and preparing for the contents; and transmitting the prepared contents to the terminal and providing the transmitted contents to the user. The user can easily obtain contents even when the user does not recognize necessary system information of a user's device, reduce time taken to convert the contents and prepare for a preliminary process, and propose a reasonable method of using intangible property rights, which leads a contents manufacturer and user into a lawful environment to work within legal boundaries. Furthermore, an existing mobile communication network is not required to download the contents, which helps to avoid overcharges. It is not necessary to prepare for contents every time the user moves.

### TECHNICAL FIELD

The present invention relates to circulation of contents, and more particularly, to a method and apparatus for providing customized contents based on information on a terminal that reproduces contents.

### BACKGROUND ART

Cellular phones which are representative personal mobile communication devices have been developed to have various additional functions. Cellular phones can already act as high resolution camera phones, receive digital multimedia broadcasting (DMB), and include a file viewer or a text viewer that was previously only embedded in conventional smart phones. Personal digital assistants (PDAs) are personal mobile compact computing devices which have become widely popular, and have been developed to provide up-to-date functions such as Internet access, personal information management, reproduction of video or MP3 files, games, file viewers, file editing, etc. Additionally, play station portables (PSPs), which are personal game devices manufactured by Sony, Inc. in Japan, have become very popular. PSPs provide functions of 2D/3D games, reproduction of video, Internet access, etc.

Also, portable multimedia players (PMPs) which are various personal multimedia devices have also become very popular. PMPs provide functions of reproduction of video, reproduction of MP3 files, GPS navigation, file viewers, text viewers, etc., and are expected to provide various modifications and improved functions.

The above portable multimedia devices are expected to face a variety of technical evolutions. For example, cellular phones having PMP functions, various multimedia devices such as portable game machines having PDA functions, etc. will appear in the near future. Hereinafter, personal media reproduction devices having the function of reproduction of multimedia, and basic functions such as file viewers, and computing devices having the above functions that are supposed to appear in the near future are referred to as portable media systems (PMSs).

PMSs are generally realized as computing systems having very various specifications. To this end, PMSs use various systems-on-chips (SoCs), digital signal processors (DSPs), etc., and a main memory and an auxiliary memory having various capacities and of various types according to the specification of PMSs.

Synchronous dynamic random access memory (SDRAM) is mainly used as the main memory. Non-volatile flash memory is widely used as the auxiliary memory. The read and write speed of flash memory cannot compete with those of SDRAM. Therefore, SDRAM is required to quickly execute programs, and two memory parts are required. However, if flash memory improves in terms of performance, it is expected that systems having flash memory will be developed in the future.

PMSs perform user interface using various display devices due to differences between manufacturing companies or usages of PMSs. Cellular phones have a variety of display units according to each model. Smart phones or PDAs generally include a relatively bigger TFT-LCD than cellular phones. Game machines or PMPs include display units having various sizes in order to express features of products according to the manufacturing companies of each device.

Users need to be informed of information on devices owned by users who use various PMSs due to differences in size and resolution of various display units, color levels, reproduction capability of computing systems, and obtain contents reproduced by users' own PMSs in advance.

For example, video reproduced by a PDA manufactured by a company A that uses a MicroSoft Windows mobile operating system cannot be reproduced by a PMP manufactured by a company B. A game operating program executed by the PDA that uses a MicroSoft Windows mobile operating system cannot be executed in a PSP manufactured by Sony, Inc. A web page seen by using a PC cannot be seen using a relatively small sized screen such as PDAs or PMPs due to the size of the screen.

In detail, each PMS includes various hardware computing constituents, has a different operating system, a different type of codec provided to assist reproduction of multimedia in each device, and a different size and specification of a display displaying a calculated image. Therefore, it is impossible to be compatible with contents used in each PMS.

Accordingly, users confirm the specification of their own PMSs, execute dedicated software provided by a manufacturing company of the PMSs in their PCs, process general video contents using the dedicated software, and convert the video contents suitable for their PMSs or download operating programs in order to attain their object.

However, users can be confused with the above process, are required to be accustomed to computing terms, need a lot of time in converting contents, and in particular, are involved in legal affairs such as infringement of intellectual property rights. Therefore, the above process must be improved.

Furthermore, even though users obtain converted contents, they cannot use the converted contents since they fail to obtain the converted contents in a timely fashion, which results in a distrust of the devices themselves. In particular, cellular phones can download video contents in real time, which overcharges users due to the fee charging policy of domestic communication companies that charge fees per packet. Therefore, it is very unfavorable to users that cannot predict the fee that will be charged, and charged fees can be very costly, which may cause social problems.

### DISCLOSURE OF INVENTION

### Technical Problem

Under these circumstances, in the case where a user has 2-3 PMSs having different specifications, it is not difficult to expect confusion incurred by the conversion of contents. The confusion will be even worse in view of the speed of the digital revolution and of social and cultural development.

### Technical Solution

The present invention provides a method and apparatus for providing customized contents based on terminal information in order to flexibly provide desired contents according to a user's terminal without an additional conversion or preparation process.

The present invention provides also a computer readable recording medium storing a method of providing customized contents based on terminal information.

According to an aspect of the present invention, there is provided a method of providing customized contents based on terminal contents, the method comprising: (a) obtaining information on a terminal that operates contents; (b) if a user selects contents, determining whether the selected contents are available or it is necessary to request a contents provider to provide the contents, if necessary, requesting the contents provider to provide the contents via a predetermined communication network and receiving the contents from the contents provider; (c) determining whether a file format of the available contents or the received contents is converted in order to perform the contents in the terminal, and if necessary, converting the file format of the contents, and preparing for the contents; and (d) transmitting the prepared contents to the terminal and providing the transmitted contents to the user.

The terminal information obtained in operation (a) includes information on an image compression format supported by the terminal, the size of spare storage space of the terminal, screen information on the terminal, types of documents supported by the terminal, a video compression format supported by the terminal, the size of main memory of the terminal, CPU information, version information of a platform and library embedded in the terminal, and types of libraries embedded in the terminal.

In operation (c), an image is converted so as to be optimized to the terminal based on the terminal information including information on the image compression format supported by the terminal, the size of spare storage space of the terminal, and screen information on the terminal.

In operation (c), a document is converted so as to be optimized to the terminal based on the terminal information including types of documents supported by the terminal, the size of spare storage space of the terminal, and screen information on the terminal.

In operation (c), video is converted so as to be optimized to the terminal based on the terminal information including information on the video compression format supported by the terminal, the size of spare storage space of the terminal, screen information on the terminal, the size of main memory of the terminal, and CPU information.

In operation (c), the contents are built based on the terminal information including information on the version of a platform and library embedded in the terminal, and types of libraries embedded in the terminal, the size of main memory of the terminal, CPU information, the size of spare storage space of the terminal, and screen information on the terminal.

In operation (b), fees are charged to the user for the contents before it is determined that the contents are available or the contents provider is requested to provide the contents.

In operation (d), the contents are provided to the user by transmitting the contents to a storage means accessible by the terminal using a wired or wireless method and storing the contents.

According to another aspect of the present invention, there is provided an apparatus for providing customized contents based on terminal information, the apparatus comprising: a terminal information obtaining unit obtaining information on a terminal that operates the contents; a user input unit receiving a user's input that selects contents; a contents determination/conversion unit determining whether the contents selected by the user are available or if it is necessary to request a contents provider to provide the contents, if necessary, requesting the contents provider to provide the contents via a predetermined communication network, receiving the contents from the contents provider, determining whether a file format of the contents is converted in order to perform the contents in the terminal, and if necessary, converting the file format of the contents, and preparing for the contents; and a transmission unit transmitting the prepared contents to the terminal and providing the transmitted contents to the user.

According to another aspect of the present invention, there is provided a computer readable recording medium storing a program for executing a method of providing customized contents based on terminal contents, the method comprising: (a) obtaining information on a terminal that operates contents; (b) if a user selects contents, determining whether the selected contents are available or it is necessary to request a contents provider to provide the contents, if necessary, requesting the contents provider to provide the contents via a predetermined communication network and receiving the contents from the contents provider; (c) determining whether a file format of the available contents or the received contents is converted in order to perform the contents in the terminal, and if necessary, converting the file format of the contents, and preparing for the contents; and (d) transmitting the prepared contents to the terminal and providing the transmitted contents to the user.

### Advantageous Effects

The user can easily obtain contents even when the user does not recognize necessary system information of a user's device, reduce time taken to convert the contents and prepare for a preliminary process, and propose a reasonable method of using intangible property rights, which leads a contents manufacturer and user into a lawful environment to work within legal boundaries. Furthermore, an existing mobile communication network is not required to download the contents, which helps to avoid overcharges. It is not necessary to prepare for contents every time the user moves.

### DESCRIPTION OF DRAWINGS

The above and other features and advantages of the present invention will become more apparent by describing in detail exemplary embodiments thereof with reference to the attached drawings in which:

FIG. 1 is a flowchart illustrating a method of providing customized contents based on terminal information according to an embodiment of the present invention;

FIG. 2 is a block diagram of an apparatus for providing customized contents based on terminal information according to an embodiment of the present invention;

FIG. 3 is a detailed flowchart illustrating a method of providing customized contents based on terminal information according to an embodiment of the present invention;

FIG. 4 is a block diagram of an apparatus for providing customized contents based on terminal information according to an embodiment of the present invention; and

FIG. 5 is a block diagram of a central control unit, a contents conversion unit, and a storage unit illustrated in FIG. 4.

### BEST MODE

The present invention will now be described more fully with reference to the accompanying drawings, in which exemplary embodiments of the invention are shown.

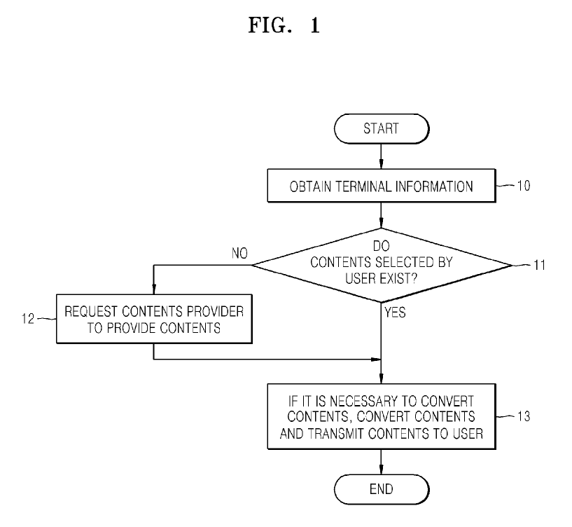

FIG. 1 is a flowchart illustrating a method of providing customized contents based on terminal information according to an embodiment of the present invention. Referring to FIG. 1, information on a terminal that operates contents is obtained (Operation 10). If a user selects the contents, it is determined whether the contents are available or if it is necessary to request a contents provider for the contents (Operation 11). The contents are transmitted from the contents provider through a predetermined communication network as the situation demands (Operation 12). It is determined whether a file format of the available contents or the transmitted contents is converted in order to operate the contents in the terminal. If it is determined that the file format is converted, the contents are transmitted to the terminal and provided to the user (Operation 13).

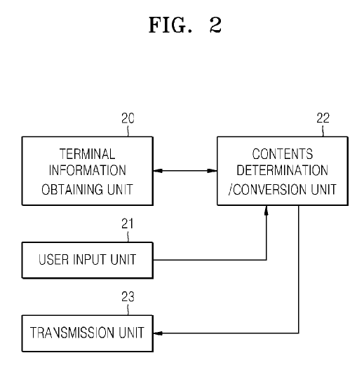

FIG. 2 is a block diagram of an apparatus for providing customized contents based on terminal information according to an embodiment of the present invention. Referring to FIG. 2, the apparatus comprises a terminal information obtaining unit 20 that obtains information on a terminal that operates contents, a user input unit 21 that receives a user's input for selecting the contents, a contents determination/conversion unit 22 that determines whether the contents are available or if it is necessary to request a contents provider for the contents, receives the contents from the contents provider through a predetermined communication network as the situation demands, determines whether a file format of the available contents or the transmitted contents is converted in order to operate the contents in the terminal, and if it is determined that the file format is converted, converts the file format of the contents, and a transmission unit 23 that transmits the contents to the terminal and provides a user with the contents.

If the contents determination/conversion unit 22 determines that the contents are available or if it is necessary to request the contents provider for other contents, the contents determination/conversion unit 22 charges a fee incurred for the provision of the contents to the user before requesting other contents.

The transmission unit 23 transmits the contents to a storage means accessed by the terminal that operates the contents using a wired or wireless method in order to provide the user with the contents. The wireless method includes wireless LAN WiFi and Bluetooth.

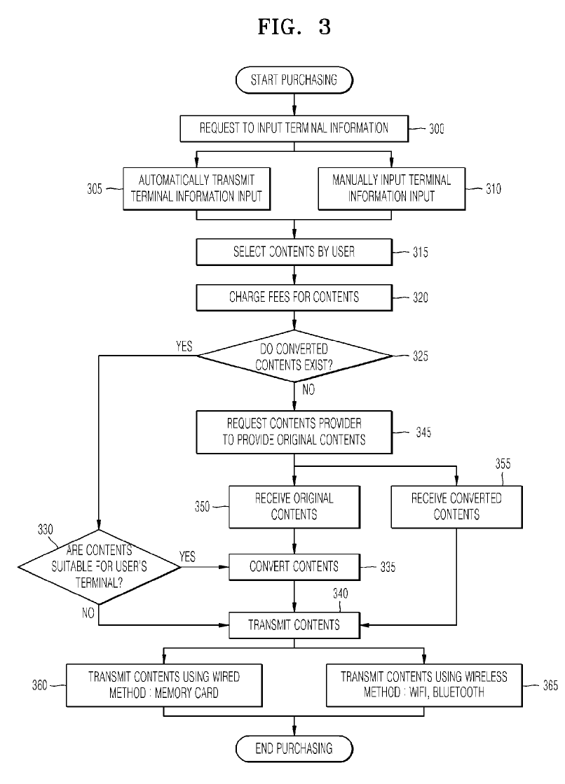

FIG. 3 is a detailed flowchart illustrating a method of providing customized contents based on terminal information according to an embodiment of the present invention. The flowchart will be described with reference to FIGS. 1 and 2.

A user accesses a nearby contents vending machine and starts a purchase sequence of contents by pressing a purchase start button included in the contents vending machine that is an apparatus according to an embodiment of the present invention.

If contents are provided, the terminal information obtaining unit 20 requests information on the specification of a portable multimedia system (PMS) device, which will reproduce or execute the contents, so as to obtain terminal information (Operation 300).

At this time, it is assumed that the information on the specification of the PMS device is previously inputted in a user's PMS device. A specification information transmission button included in the PMS device is pressed in order to exchange messages including information on the apparatus according to an embodiment of the present invention and the PMS device (Operation 305).

The messages are exchanged using known various wireless transmission technologies such as infrared data (IrDA), wireless transmission, etc.

Alternatively, the PMS device is connected to a means such as a cable provided by the apparatus according to the present invention, and the terminal information obtaining unit 20 is connected to the PMS device by means of the cable so as to obtain information on the PMS device. The cable is used to transmit contents desired by the user from the apparatus according to the present embodiment to the user's PMS device. Without the cable, the apparatus according to the present embodiment can access the PMS device using various wireless transmission technologies described in Operation 305.

For another example, the user inputs the specification of the user's terminal, i.e., the PMS device, through a screen interface provided by the terminal information obtaining unit 20 (Operation 310).

The terminal information includes information on an image compression format supported by the terminal, the size of spare storage space of the terminal, the screen of the terminal, types of documents supported by the terminal, a video compression format supported by the terminal, the size of the main memory of the terminal, CPU information, the version of a platform and library embedded in the terminal, and types of libraries embedded with the terminal. One example of terminal information is described in Table 1.

TABLE 1

| Specification of PMS device | Specification Examples |
|---|---|
| PMS manufacturing company | XX electronics company |
| PMS model name | PMS-100 |
| Screen size | 4 inches |
| Screen resolution | 480*640 |
| Color resolution | 65,536 colors |
| CPU specification | Intel PXA270 |
| Internal memory size | 128MB |
| External memory size | 1 GB |
| Usable wireless transmission | Bluetooth v1.2, WiFi |
| method | 802.11a/b/g |
| Maximum reproduction FPS | 30 |
| (frame per second) | |
| Usable memory size | 100 MB |
| Platform version | WIPI 2.0 |
| Platform Library Version | SKTlbs1.0; SKTopenGL1.1 |
| Support multimedia | MPEG4, H.263, MJPEG, MP3, |
| | JPEG, PNG, PDF, HTML, TXT |

Supports according to the present invention for each detail described in Table 1 are described below.

If the user's PMS device does not have the above automatic transmission function, the user selects a device manufacturing company and a device name so that the user input unit 21 can provide a user interface so as to provide information on the user's PMS device. If the user inputs information indicating the device manufacturing company and a device name or a device model name, the terminal information obtaining unit 20 compares information provided by the manufacturing company with the information on the user's PMS device, automatically constitutes information as described in Table 1, and obtains information on the user's terminal.

If information on a device used is completely transmitted in order to obtain information on the terminal, the user can search and select desired contents. The desired contents can be divided into four types of contents. First, contents desired by the user are included in the apparatus according to an embodiment of the present invention so that the contents can be provided immediately. Second, although the contents are included in the apparatus according to the present embodiment, it is necessary to convert the contents in order to use the contents in a user's terminal device. Third, since the contents desired by the user are not included in the apparatus according to the present embodiment, it is necessary to request a contents provider to provide the contents. Fourth, since the contents desired by the user are not included in the apparatus according to the present embodiment, it is necessary to request the contents provider to provide contents suitable for the user's terminal device. The user can select the contents from among the four types of contents from a recommendation menu provided by the user input unit 21 using a screen interface (Operation 315). The selected contents are input by the user input unit 21.

The contents determination/conversion unit 220 charges fees according to the type of selected contents (Operation 320) using various existing payment methods such as real money, a credit card, a cellular phone, etc.

If the fees are completely paid, the contents are prepared. During the preparation of the contents, the contents determination/conversion unit 22 searches space in which previously prepared contents are stored to determine whether the contents selected by the user exist in the space based on the terminal information obtained during Operations 300 through 310 (Operation 325), and determines whether the contents are suitable for the user's terminal (Operation 330). If it is not necessary to convert the format of the contents, the transmission unit 23 transmits the contents to the user's terminal, i.e., a terminal whose information is obtained (Operation 340).

Although the contents desired by the user exist in Operation 325, if it is necessary to convert the file format of the contents in Operation 330, the contents determination/conversion unit 22 converts the contents according to information on a user's terminal (Operation 335), and the transmission unit 23 transmits the converted contents to the user's terminal (Operation 340).

If the contents selected by the user are not prepared in Operation 325, the contents determination/conversion unit 22 accesses a server of a predetermined contents provider and requests the contents (Operation 345).

If previously converted contents suitable for the information on the user's terminal are received (Operation 355), the contents are immediately transmitted to the user's terminal (Operation 340). However, if it is still necessary to convert the contents, the contents determination/conversion unit 22 receives the original contents (Operation 350), converts the received contents that are to be reproduced in the user's terminal (Operation 335), and transmits the converted contents to the user's terminal through the transmission unit 23.

The transmission unit 23 transmits the converted contents to the user's terminal using a wired/wireless interface (Operations 360 and 365). Then the user's terminal downloads the contents.

The contents are downloaded to an auxiliary memory previously owned by the user by means of a memory reader in the front of a contents vending machine. The auxiliary memory is a recordable medium accessed or approached by the user's terminal.

Therefore, the contents are reproduced by connecting the auxiliary memory to the user's terminal.

If the user does not have the auxiliary memory, the contents can be downloaded in the user's terminal by means of a wireless interface attached to a PMS, which is the user's terminal. In this case, the transmission unit 23 of the apparatus according to an embodiment of the present invention is operated so as to be connected to the user's terminal by means of the wireless interface used by the user's terminal based on the information described in Table 1.

Even if the specification of the user's terminal is not good or the user does not have the auxiliary memory, the user can purchase a memory card on the spot, download the contents using the memory card, and enjoy the contents using the user's terminal.

If the contents are completely transmitted, the apparatus according to an embodiment of the present invention terminates a contents transmission process and returns to an initial standby state. The contents converted in Operation 335 are registered in a predetermined storing unit of the apparatus according to an embodiment of the present invention. If the storing unit lacks a storing space or exceeds a publication period, the registered contents are automatically discarded. Alternatively, a contents database (DB) is configured to be registered so that the converted contents can be managed by the contents DB.

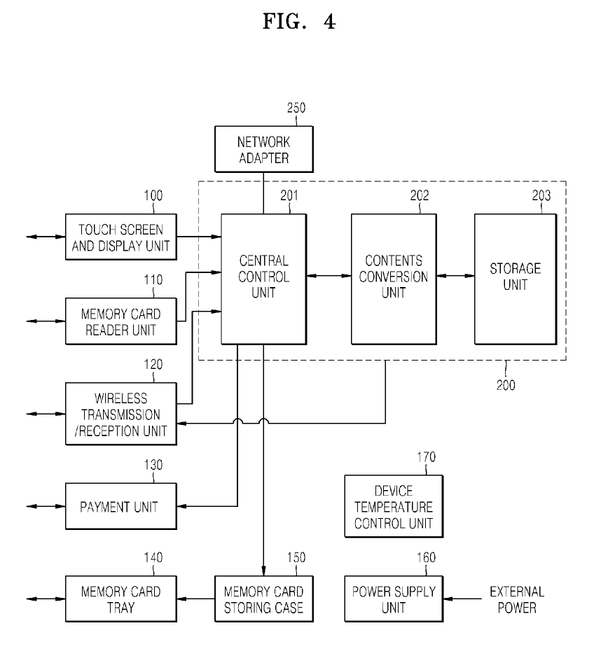

FIG. 4 is a block diagram of an apparatus for providing customized contents based on terminal information according to an embodiment of the present invention. The apparatus of the current embodiment of the present invention includes the apparatus illustrated in FIG. 2. Referring to FIG. 4, a touch screen and display unit 100, which is the main user interface of the present invention, constitutes a graphic user interface (GUI) that displays each user interface necessary for operations illustrated in FIG. 3, displays selections for a user, receives a response input, and provides a user with a screen interface that inputs user's request matters in order to use the apparatus of the current embodiment according to a predetermined process.

A memory card reader unit 110 downloads contents purchased by the user through wire or cable. In detail, the user prepares a memory card suitable for the user's PMS device in advance, inserts the memory card into the memory card reader unit 110, and purchases contents using the memory card and the memory card reader unit 110.

A wireless transmission/reception unit 120 manually receives information on the user's terminal or downloads wirelessly purchased contents using a variety of wireless communication methods including Bluetooth or wireless LAN WiFi.

The memory card reader unit 110 and the wireless transmission/reception unit 120 implement most functions of the transmission unit 23 illustrated in FIG. 2.

A payment unit 130 charges fees of purchased contents using various existing methods such as cash, a credit card, e-money, a cellular phone payment, etc.

A memory card tray 140 is a withdrawal slot used to withdraw a semiconductor memory card or a memory storage unit stored in a memory card storing case 150 which is sold to a customer in order to purchase a memory card on the spot if the customer fails to obtain a memory card that is suitable for the contents.

A power supply unit 160 supplies power to the apparatus of the current embodiment of the present invention. A device temperature control unit 170 controls the temperature inside the device in order to maintain stable device operation conditions, and is constituted as a cooler, fan, etc.

A network adapter 250 is an Internet connector used in the apparatus of the current embodiment of the present invention, and can be used as an existing Internet service provider network.

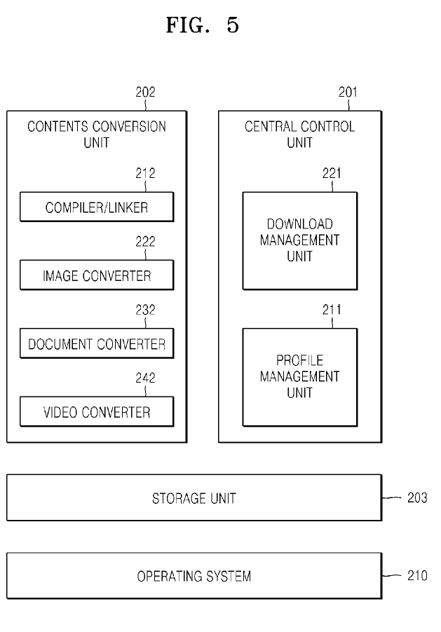

A central control unit 201, a contents conversion unit 202, and a storage unit 203 will be described with reference to FIG. 5. The central control unit 201 and the contents conversion unit 202 perform most functions of the terminal information obtaining unit 20 and the contents determination/conversion unit 22 illustrated in FIG. 2. The central control unit 201 and the contents conversion unit 202 can be performed via a program suitable for a CPU of a device such as a computer or a server system, or can be realized as another hardware. The following description is based on the program.

FIG. 5 is a block diagram of the central control unit 201, the contents conversion unit 202, and the storage unit 203 illustrated in FIG. 4. A method of providing customized contents based on terminal information according to an embodiment of the present invention will now be described with reference to FIG. 5.

If a user selects contents to be purchased, a profile management unit 211 of the central control unit 201 extracts a profile of a user's terminal. A download management unit 221 determines whether the contents selected by the user are included in a storage space of an apparatus of an embodiment of the present invention. If the contents, which are converted so as to be suitable for the user's terminal, are included in the storage space, the contents are downloaded to the user's terminal.

If the contents, which are converted so as to be suitable for the user's terminal, are not included although the original contents exist, the contents conversion unit 202 converts the contents. If a vending machine does not include the original contents, the download management unit 221 requests a contents provider to provide the original contents, downloads the original contents to the apparatus of the present embodiment through the network adapter 250, converts the original contents so as to be suitable for the user's terminal through the contents conversion unit 202, and finally downloads the converted contents to the user's terminal.

The contents conversion unit 202 includes an image converter 222, a document converter 232, and a video converter 242 for converting multimedia data, and a compiler/linker 212 for converting an operating program operated in the user's terminal.

The image converter 222 converts an image that is to be optimized to the user's terminal based on information including information on an image compression format supported by the user's terminal, the size of spare storage space of the user's terminal, screen information of the user's terminal, etc.

The document converter 232 converts a document that is to be optimized to the user's terminal based on information including information on types of documents supported by the user's terminal, the size of spare storage space of the user's terminal, screen information on the user's terminal, etc.

The video converter 242 converts video that is to be optimized to the user's terminal based on information including information on a video compression format supported by the user's terminal, the size of spare storage space of the user's terminal, screen information on the user's terminal, the size of main memory of the user's terminal, CPU information, etc.

The compiler/linker 212 rebuilds contents using information including information on the version of a platform and library embedded in the terminal, types of libraries embedded with the user's terminal, the size of main memory of the terminal, CPU information, the size of spare storage space of the user's terminal, screen information on the user's terminal, etc.

The contents converted so as to be suitable for the user's terminal by using the above processes are stored in the storage unit 203 according to the processing of the central control unit 201 or deleted after an available period expires or under other conditions.

It is obvious that the contents conversion unit 202 does not convert the contents but instead the download management unit 221 of the central control unit 201 transmits terminal information to the contents provider, downloads contents which are converted so as to be suitable for the user's terminal, and downloads the converted contents to the user's terminal.

According to the present invention, a user can easily obtain contents even when the user does not recognize necessary system information of a user's device, reduce time taken to convert the contents and prepare for a preliminary process, and propose a reasonable method of using intangible property rights, which leads a contents manufacturer and user into a lawful environment to work within legal boundaries. Furthermore, an existing mobile communication network is not required to download the contents, which avoid overcharges. It is not necessary to prepare for contents whenever the user moves.

It is obvious to those of ordinary skill in the pertinent art that each operation of the present invention can be implemented in a software or hardware manner using a general programming method.

The present invention can also be implemented as computer-readable code on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, and carrier waves (such as data transmission through the Internet). The computer-readable recording medium can also be distributed over network-coupled computer systems so that the computer-readable code is stored and executed in a distributed fashion.

The present invention can be used in the circulation of digital contents.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of providing customized contents based on terminal contents, the method comprising:
(a) obtaining information on a terminal that operates contents;
(b) if a user selects contents, determining whether the selected contents are available or it is necessary to request a contents provider to provide the contents, if necessary, requesting the contents provider to provide the contents via a predetermined communication network and receiving the contents from the contents provider;
(c) determining whether a file format of the available contents or the received contents is converted in order to perform the contents in the terminal, and if necessary, converting the file format of the contents, and preparing for the contents; and
(d) transmitting the prepared contents to the terminal and providing the transmitted contents to the user.

2. The method of claim 1, wherein the terminal information obtained in operation (a) includes information on an image compression format supported by the terminal, the size of spare storage space of the terminal, screen information on the terminal, types of documents supported by the terminal, a video compression format supported by the terminal, the size of main memory of the terminal, CPU information, version information of a platform and library embedded in the terminal, and types of libraries embedded in the terminal.

3. The method of claim 1, wherein, in operation (c), an image is converted so as to be optimized to the terminal based on the terminal information including information on the image compression format supported by the terminal, the size of spare storage space of the terminal, and screen information on the terminal.

4. The method of claim 1, wherein, in operation (c), a document is converted so as to be optimized to the terminal based on the terminal information including types of documents supported by the terminal, the size of spare storage space of the terminal, and screen information on the terminal.

5. The method of claim 1, wherein, in operation (c), video is converted so as to be optimized to the terminal based on the terminal information including information on the video compression format supported by the terminal, the size of spare storage space of the terminal, screen information on the terminal, the size of main memory of the terminal, and CPU information.

6. The method of claim 1, wherein, in operation (c), the contents are built based on the terminal information including information on the version of a platform and library embedded in the terminal, and types of libraries embedded in the terminal, the size of main memory of the terminal, CPU information, the size of spare storage space of the terminal, and screen information on the terminal.

7. The method of claim 1, wherein, in operation (b), fees are charged to the user for the contents before it is determined that the contents are available or the contents provider is requested to provide the contents.

8. The method of claim 1, wherein, in operation (d), the contents are provided to the user by transmitting the contents to a storage means accessible by the terminal using a wired or wireless method and storing the contents.

9. The method of claim 3, wherein the wireless method includes a wireless LAN and Bluetooth.

10. An apparatus for providing customized contents based on terminal information, the apparatus comprising:
a terminal information obtaining unit obtaining information on a terminal that operates the contents;
a user input unit receiving a user's input that selects contents;
a contents determination/conversion unit determining whether the contents selected by the user are available or if it is necessary to request a contents provider to provide the contents, if necessary, requesting the contents provider to provide the contents via a predetermined communication network, receiving the contents from the contents provider, determining whether a file format of the contents is converted in order to perform the contents in the terminal, and if necessary, converting the file format of the contents, and preparing for the contents; and
a transmission unit transmitting the prepared contents to the terminal and providing the transmitted contents to the user.

11. The apparatus of claim 10, wherein the user input unit receives information on the terminal that operates the contents from the user.

12. The apparatus of claim 10, wherein the terminal information obtained by the terminal information obtaining unit includes information on an image compression format supported by the terminal, the size of spare storage space of the terminal, screen information on the terminal, types of documents supported by the terminal, a video compression format supported by the terminal, the size of main memory of the terminal, CPU information, version information of a platform and library embedded in the terminal, and types of libraries embedded in the terminal.

13. The apparatus of claim 10, wherein the contents determination/conversion unit comprises:
an image converter converting an image that is to be optimized to the terminal based on the terminal information including information on the image compression format supported by the terminal, the size of spare storage space of the terminal, and screen information on the terminal;
a document converter converting a document that is to be optimized to the terminal based on the terminal information including information on types of documents supported by the terminal, the size of spare storage space of the terminal, and screen information on the terminal;
a video converter converting video that is to be optimized to the terminal based on the terminal information including information on the video compression format supported by the terminal, the size of spare storage space of the terminal, screen information on the terminal, the size of main memory of the terminal, and CPU information; and
a compiler/linker rebuilding the contents based on the terminal information including information on the version of platform and library embedded in the terminal, and types of libraries embedded in the terminal, the size of main memory of the terminal, CPU information, the size of spare storage space of the terminal, and screen information on the terminal.

14. The apparatus of claim 10, wherein the contents determination/conversion unit charges fees to the user for the contents before determining that the contents are available or requesting the contents provider to provide the contents.

15. The apparatus of claim 10, wherein the transmission unit transmits the contents to a storage means accessible by the terminal that operates the contents using a wired or wireless method and stores the contents.

16. A computer readable recording medium storing a program for executing a method of providing customized contents based on terminal contents, the method comprising:
(a) obtaining information on a terminal that operates contents;
(b) if a user selects contents, determining whether the selected contents are available or it is necessary to request a contents provider to provide the contents, if necessary, requesting the contents provider to provide the contents via a predetermined communication network and receiving the contents from the contents provider;
(c) determining whether a file format of the available contents or the received contents is converted in order to perform the contents in the terminal, and if necessary, converting the file format of the contents, and preparing for the contents; and
(d) transmitting the prepared contents to the terminal and providing the transmitted contents to the user.
